(19) United States
(12) Patent Application Publication
(10) Pub. No.: US 2013/0344618 A1
(43) Pub. Date: Dec. 26, 2013

(54) BIOSENSOR USING AGGLOMERATION OF MAGNETIC NANOPARTICLES AND DETECTION METHOD BY THE SAME

(71) Applicants: Hye Jung SEO, Chuncheon-si Gangwon-do (KR); Sang Min JEON, Pohang-si (KR); Soo Suk LEE, Suwon-si (KR); Youn Suk CHOI, Yongin-si (KR); Jung Nam LEE, Incheon (KR); Joon Hyung LEE, Yongin-si (KR); Kyung Yeon HAN, Seoul (KR); Dong Kyu LEE, Daegu (KR); Jin Young PARK, Pohang-si (KR)

(72) Inventors: Hye Jung SEO, Chuncheon-si Gangwon-do (KR); Sang Min JEON, Pohang-si (KR); Soo Suk LEE, Suwon-si (KR); Youn Suk CHOI, Yongin-si (KR); Jung Nam LEE, Incheon (KR); Joon Hyung LEE, Yongin-si (KR); Kyung Yeon HAN, Seoul (KR); Dong Kyu LEE, Daegu (KR); Jin Young PARK, Pohang-si (KR)

(73) Assignees: POSTECH ACADEMY INDUSTRY FOUNDATION, Pohang-si (KR); SAMSUNG ELECTRONICS CO., LTD., Suwon-si (KR)

(21) Appl. No.: 13/368,849

(22) Filed: Feb. 8, 2012

(30) Foreign Application Priority Data
Aug. 4, 2011 (KR) 10-2011-0077737

(51) Int. Cl. G01N 27/72

(52) U.S. Cl. CPC G01N 27/72
USPC 436/501; 422/69

(57) ABSTRACT

A biosensor and method for detecting a target material using an agglomeration of magnetic nanoparticles are provided.

### CROSS-REFERENCE TO RELATED APPLICATION

This application claims the benefit of Korean Patent Application No. 10-2011-0077737, filed on Aug. 4, 2011, and all the benefits accruing therefrom under 35 U.S.C. §119 which is hereby incorporated by reference as if fully set forth herein.

### BACKGROUND

A biosensor typically is configured to quantitatively and qualitatively analyze and diagnose biological molecules by causing signals to be changed electrically or optically by means of specific binding or reaction between a surface of the biosensor and the biological molecule. Examples of such biological molecules include proteins, DNA, viruses, bacteria, cells, tissue, and so on.

Examples of the methods of detecting a biological molecule using a biosensor include immunogold silver staining (“IGSS”), enzyme-catalyzed reduction reaction, and metallic ion reduction using photocatalyst nanoparticles. In these techniques, however, rapid detection of a biological molecule is difficult and there is a limit to how small an amount of the biological molecule can be detected with high sensitivity.

On the other hand, in recent years, nano-sized materials with a small diameter are emerging as important substances due to their unique physical, chemical, mechanical and electronic properties.

### SUMMARY

A biosensor and method for detecting a target material rapidly and with high sensitivity by using an agglomeration of magnetic nanoparticles are provided.

According to an aspect, there is provided a biosensor including a substrate having a receptor immobilized thereon, the receptor capable of reacting specifically with a target material; first magnetic nanoparticles each with a receptor immobilized thereon, wherein the receptor immobilized on the first magnetic nanoparticles is the same type as that immobilized on the substrate; a magnetic field source positioned to apply a magnetic field to the first magnetic nanoparticles; and second magnetic nanoparticles that agglomerate with the first magnetic nanoparticles in the presence of a magnetic field.

In a related aspect, a multi-component probe set is provided, comprising at least one first magnetic nanoparticle comprising a receptor for a target material; and a plurality of second magnetic nanoparticles that are different from the first magnetic nanoparticle, and which agglomerate with the first magnetic nanoparticle in the presence of a magnetic field. The probe can be used in a biosensor further comprising, for instance, a magnetic field source configured to apply a magnetic field to the magnetic nanoparticles; and a sensor that detects agglomeration of the at least one first magnetic particle with a plurality of second magnetic particles.

According to another aspect, there is provided a method for detecting a target material including immobilizing a receptor on a substrate, the receptor capable of specifically reacting with a target material; immobilizing a second receptor of the same type on each of a plurality of first magnetic nanoparticles; reacting the target material with the receptor immobilized on the substrate and the receptor immobilized on the first magnetic nanoparticles, thereby binding the first magnetic nanoparticles to the substrate; magnetizing the first magnetic nanoparticles; adhering second magnetic nanoparticles to the first magnetic nanoparticles; and detecting agglomeration of the first magnetic nanoparticles and the second magnetic nanoparticles, which indicates the presence of the target material.

With the method for detecting a target material using an agglomeration of the magnetic nanoparticles, the mass and magnitude of the magnetic nanoparticles may be increased, thereby detecting the target material rapidly and with high sensitivity.

### BRIEF DESCRIPTION OF THE DRAWINGS

The above and other aspects of this disclosure will become more readily apparent by describing in further detail non-limiting example embodiments thereof with reference to the accompanying drawings, in which:

FIG. 1 is a schematic diagram showing an embodiment of a method of detecting a target material using an agglomeration of magnetic nanoparticles;

FIG. 2 is a graph showing a change in deflections of a microcantilever according to Example 2, wherein E represents the number of agglomeration reactions among the magnetic nanoparticles; and

FIG. 3 is a graph showing a change in a resonant frequency of the microcantilever according to Example 3.

### DETAILED DESCRIPTION

The invention now will be described more fully hereinafter with reference to the accompanying drawings, in which a non-limiting embodiment is shown. This invention may, however, be embodied in many different forms, and should not be construed as limited to the embodiments set forth herein. Rather, these embodiments are provided so that this disclosure will be thorough and complete, and will fully convey the scope of the invention to those of ordinary skill in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

### Magnetic Nanoparticles

Exemplary embodiments provide a biosensor and method for detecting a target material rapidly and with high sensitivity by using an agglomeration of magnetic nanoparticles.

“Magnetic,” as used herein, refers to magnetic properties of a material. Material interacts with a magnetic field, generating either an attractive force or a repulsive force. Specifically, if a magnetic field is applied to a magnetic material, the material becomes magnetized. The magnetized material is classified into ferromagnetic, paramagnetic, antiferromagnetic, and ferrimagnetic material depending on the type of magnetization resulting from the application of a magnetic field.

The ferromagnetic material is a substance which is strongly magnetized in the same direction as a magnetic field when a strong magnetic field is externally applied and remains magnetized even after the external magnetic field is removed. Examples of the ferromagnetic material include iron, cobalt, nickel, alloys thereof, and so on.

The paramagnetic material is a substance which is weakly magnetized in the same direction as an external magnetic field upon application of the magnetic field and has no remaining magnetism after the external magnetic field is removed. Examples of the paramagnetic material include metals such as aluminum, tin, platinum and iridium; oxygen; air; and so on.

The antiferromagnetic material is a substance which is magnetized in the opposite direction as an externally applied magnetic field. Examples of the antiferromagnetic material include metals (e.g., gold, silver and copper), most gases except for oxygen, organic compounds, salts, water, glass, and so on.

The ferrimagnetic material is a substance which is strongly magnetized in the same direction as an externally applied magnetic field. The magnetization direction of the ferrimagnetic material is similar to that of the ferromagnetic material, but the magnetization mechanism of the ferrimagnetic material is similar to that of antiferromagnetic material. The magnetic moments of adjacent magnetic ions in the crystal coincide with each other in opposite directions. The ferrimagnetic material having a similar property to the ferromagnetic material is magnetized more strongly than other materials, since the number of magnetic ions having magnetic moments arranged in opposite directions is different and the remaining magnetic ions have the same magnetic force as the ferromagnetic material. An example of the ferromagnetic material may include a metallic oxide such as magnetite or ferrite.

As used herein, the term “nanoparticle” refers to a structure or substance having a nanometer (nm) size. The nanometer size is a thousandth of a micrometer size (10⁻⁶). Any material in a nanometer size exhibits unique physical, chemical, mechanical, and electronic properties.

The average size of a nanoparticle generally ranges from about 1 nm to about 1000 nm, for example about 1 nm to about 10 nm, about 10 nm to about 50 nm, about 50 nm to about 100 nm, about 100 nm to about 250 nm, about 250 nm to about 500 nm, about 500 nm to about 750 nm, or about 750 nm to about 1000 nm.

As used herein, the term “magnetic nanoparticle” refers to a nanometer-sized structure or substance with a magnetic force. The magnetic nanoparticles may be fabricated by solution composition, coprecipitation, a sol-gel process, high energy spallation, hydro-thermal synthesis, micro-emulsion synthesis, synthesis by thermal decomposition, or sonic chemical synthesis, but is not limited thereto.

If the size of the magnetic material is reduced to nanometer, the nanoparticles form their respective magnetic regions. In the colloid solution containing these particles, its magnetic dipoles are oriented in irregular directions by thermal fluctuations of the particles, such that the net magnetic force may be zero superficially. When the magnetic force of an externally applied magnetic field is greater than an inner thermal energy, the magnetic dipoles of the particles are arranged in one direction, thereby becoming magnetic materials.

### Biosensor

According to an aspect, there is provided a biosensor using an agglomeration of magnetic nanoparticles. The biosensor includes a substrate having a receptor (or plurality of receptors) immobilized thereon, the receptor capable of reacting specifically with (e.g., binding to) a target material; a plurality of first magnetic nanoparticles each having a receptor immobilized thereon, the receptor immobilized on the first magnetic nanoparticles being the same type as the receptor immobilized on the substrate; a magnetic field source positioned or configured so as to apply a magnetic field to the first magnetic nanoparticles; and a plurality of second magnetic nanoparticles that agglomerate with the first magnetic nanoparticles in the presence of a magnetic field.

As used herein, the term “biosensor” refers to a device capable of detecting a target material qualitatively and quantitatively, for example, on the basis of a specific reaction or property of a biological material. Biosensors may be classified into mass-based sensors, optical sensors, electrical sensors, and magnetic-based sensors according to a detection method. The mass-based sensors may include, for example, a quartz crystal microbalance (“QCM”), a cantilever sensor, a surface acoustic wave (“SAW”) sensor, and so on. The optical sensors may include, for example, a sensor using UV-visible spectrometry, colorimetry, surface plasmon resonance, and so on. The electrical sensors may include electrochemistry sensors and field effect transistor (“FET”) sensors. The magnetic-based sensors may include, for example, magnetic force microscopy (“MFM”). In an illustrative example, a cantilever sensor can be employed as the biosensor.

As used herein, the term “target material” refers to a material, such as a biological molecule, to be detected or otherwise analyzed by the biosensor. The target material may be at least one of an enzyme substrate, a ligand, an antigen, an antibody, a nucleotide, an amino acid, a peptide, a protein, a nucleic acid, a lipid, a carbohydrate, an organic compound, or an inorganic compound, but is not limited thereto. In an example, an alpha-fetoprotein (“AFP”) antigen can be employed as the target material. The target material can, for instance, be a component of a sample, particularly a sample of a biological material (tissue or body fluid) or a sample derived from a biological material.

As used herein, the term “receptor” refers to a material which can specifically react with a target material, for example, by binding to the target material. The receptor may be at least one of an enzyme substrate, a ligand, an antigen, an antibody, a nucleotide, an amino acid, a peptide, a protein, a nucleic acid, a lipid, a carbohydrate, an organic compound, or an inorganic compound, but is not limited thereto. In an example, a polyclonal alpha-fetoprotein (“AFP”) antibody was employed as the receptor. The receptor is considered to specifically react with, or bind to, the target material if it reacts with or binds to the target material preferentially over other similar materials. The receptor can also be referred to as a binding moiety or probe for the target material.

The receptor may be immobilized on a substrate and first magnetic nanoparticles by a covalent bond or non-covalent bond. The receptor may be directly adhered to surfaces of the substrate and the first magnetic nanoparticles, or may be adhered using a linker after treating the surfaces of the substrate and the first magnetic nanoparticles.

For example, the surfaces of the substrate and the first magnetic nanoparticles may be treated with at least one of aminopropyltriethoxysilane (“APTES”), glycidoxypropyltrimethoxysilane (“GPTS”), triethoxysilane undecanoic acid (“TETU”), polylysine, and 4-trimethoxysilylbenzaldehyde, but are not limited thereto. Furthermore, the surface-treated substrate and first magnetic nanoparticles may be reformed into materials known in the art such as glutaraldehyde, acetic acid, and so on. In an example, the surfaces of the substrate and the first magnetic nanoparticles were treated with APTES and reformed with glutaraldehyde, and then a polyclonal AFP antibody was adhered thereto.

As used herein, the term “substrate” refers to a thin plate made of a material having no magnetic property so as not to affect the magnetic nanoparticles. The substrate may comprise silicon (e.g., a silicon wafer), glass, quartz, metal, plastic, or a combination thereof, but is not limited thereto. In an example, a silicon wafer can be employed as the substrate.

As used herein, the term “first magnetic nanoparticle” refers to magnetic nanoparticle on a surface of which a receptor capable of specifically reacting with a target material is immobilized. The first magnetic nanoparticles may be ferromagnetic nanoparticles or paramagnetic nanoparticles. The first magnetic nanoparticles may be used in the form of the magnetic particles, the particles in which all or some are coated with an organic or inorganic material, or the particles coated with an organic or inorganic material on the surface of the magnetic particles.

The ferromagnetic nanoparticles may be at least one of cobalt, iron, nickel, or alloys thereof, but are not limited thereto. The paramagnetic nanoparticles may be at least one of aluminum, tin, or platinum, but are not limited thereto.

An average diameter of the first magnetic nanoparticles may range from about 1 nm to about 1000 nm. If the average diameter of the first magnetic nanoparticles is less than about 1 nm, the surface area for binding is so small that the efficiency may be reduced. On the other hand, if the average diameter of the first magnetic nanoparticles is more than about 1000 nm, the first magnetic nanoparticles may not be suitable for compact sensors. In an example, FeNi (“Ferronickel”) ferromagnetic nanoparticles having a diameter of about 100 nm may be employed as the first magnetic nanoparticles.

As used herein, the term “second magnetic nanoparticle” refers to a substance which is adhered to the magnetized first magnetic nanoparticles and can agglomerate with the first magnetic nanoparticles in the presence of a magnetic field. The second magnetic nanoparticles may be ferromagnetic nanoparticles or paramagnetic nanoparticles. The second magnetic nanoparticles can be the same or different from the first magnetic nanoparticles. Notably, the second magnetic nanoparticles are not required to have a receptor for the target material immobilized on the surface thereof. The second magnetic nanoparticles do not comprise a receptor for the target material immobilized on the surface thereof.

An average diameter of the second magnetic nanoparticles may range from about 1 nm to about 1000 nm, but is not limited thereto. In an example, FeNi ferromagnetic nanoparticles having a diameter of about 100 nm may be employed as the second magnetic nanoparticles.

As used herein, the term “magnetic field source” refers to an object which can apply a magnetic field to magnetize magnetic nanoparticles. The magnetic field source may be, for example, a permanent magnet having an electromotive force ranging from about 800 to 1200 gauss, but is not limited thereto. In an example, a permanent magnet having an electromotive force of about 1000 gauss can be employed.

### Method of Detecting Target Material

According to another aspect, there is provided a method for detecting a target material by using an agglomeration of magnetic nanoparticles. The method comprises: immobilizing a receptor on a substrate, the receptor capable of reacting specifically with a target material; immobilizing a receptor on first magnetic nanoparticles, the receptor on the first magnetic nanoparticles being the same type as the receptor immobilized on the substrate; reacting the target material with the receptor immobilized on the substrate and the receptor immobilized on the first magnetic nanoparticles, thereby binding the first magnetic nanoparticles to the substrate; magnetizing the first magnetic nanoparticles; adhering second magnetic nanoparticles to the first magnetic nanoparticles; and detecting agglomeration (e.g., a change do to agglomeration) of the first magnetic nanoparticles and the second magnetic nanoparticles. Reacting the target material with the receptors on the substrate and/or nanoparticles can be accomplished by contacting the target material (e.g., a sample comprising a target material) with the receptors, e.g., by contacting the target material with the substrate comprising the immobilized receptors and/or the nanoparticles comprising the immobilized receptor. Adhering the second magnetic nanoparticles can be facilitated by applying a magnetic field to the first magnetic nanoparticles in the presence of the second magnetic nanoparticles, whereby the magnetic attraction between the magnetized particles causes the second magnetic nanoparticles to adhere to the first magnetic nanoparticles. In this respect, the magnetic field can be applied before, after, or simultaneously with the addition of the second magnetic nanoparticles.

The method also can be performed using a pre-prepared substrate comprising receptors for the target material, optionally having the target substance already bound to the substrate (receptors). Thus, in another aspect, the method comprises contacting a target material bound to a substrate with a plurality of first magnetic nanoparticles each comprising a receptor for the target material, wherein at least a portion of the first magnetic nanoparticles bind at least a portion of the target material; contacting the target material with a plurality of second magnetic nanoparticles that agglomerate with the first magnetic nanoparticles in the presence of a magnetic field; applying a magnetic field to the first magnetic nanoparticles in the presence of the second magnetic nanoparticles; and detecting agglomeration of the first magnetic nanoparticles and the second magnetic nanoparticles on the substrate. According to this aspect, the method can optionally further comprise providing a target material bound to a substrate by contacting a target material with a substrate comprising a plurality of receptors for the target material, whereupon the receptors bind to and immobilize the target material.

Agglomeration of the first magnetic nanoparticles with the second magnetic nanoparticles on the substrate indicates the presense of the target material on the substrate. In some embodiments, the methods described herein can further comprise a step of removing unreacted (unbound) first magnetic nanoparticles, for example, by washing the substrate after contact with the first magnetic nanoparticles or any subsequent step. The unreacted (unbound) magnetic nanoparticles also can be removed using a magnetic field or magnetic material to attract and collect the particles.

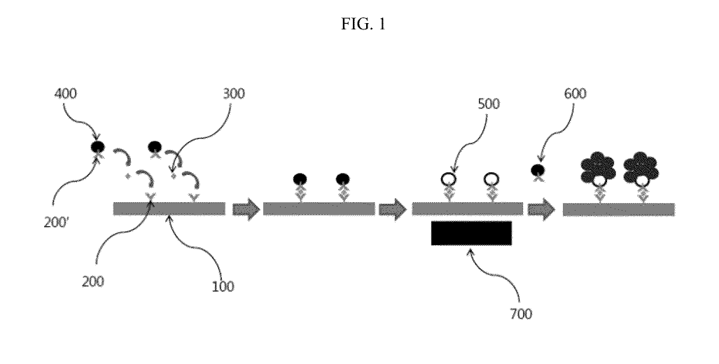

FIG. 1 illustrates a schematic diagram of the method of detecting a target material. The method for detecting a target material will now be described more fully with reference to the accompanying drawings.

First, a receptor 200 capable of specifically reacting with a target material 300 is immobilized on a substrate 100, and then a receptor 200′ being the same type as the receptor 200 is immobilized on first magnetic nanoparticles 400. For example, in order to detect an AFP antigen, a polyclonal AFP antibody specifically reacting with the antigen may be immobilized on the surfaces of a silicon microcantilever and FeNi ferromagnetic nanoparticles.

In this case, the substrate and the first magnetic nanoparticles may be surface-treated. For example, the silicon microcantilever and the FeNi ferromagnetic nanoparticles may be surface-treated with APTES, and then the polyclonal AFP antibody may be adhered thereto by means of glutaraldehyde.

Next, the target material 300 reacts with the receptor 200 immobilized on the substrate and the receptor 200′ immobilized on the first magnetic nanoparticles 400, thereby binding the first magnetic nanoparticles to the substrate. For example, the AFP antigen reacts with the polyclonal AFP antibody immobilized on the surface of the silicon microcantilever and the polyclonal AFP antibody immobilized on the surface of the FeNi ferromagnetic nanoparticles, and then the silicon microcantilever and the FeNi ferromagnetic nanoparticles may be bound by way of a sandwich method. That is, a structure in which the AFP antigen corresponds to a core and the polyclonal AFP antibody is surrounding the AFP antigen, may be formed.

Next, the first magnetic nanoparticles 400 are magnetized by a magnet 700, and then second magnetic nanoparticles 600 are adhered to the magnetized first magnetic nanoparticles 500. The first magnetic nanoparticles and the second magnetic nanoparticles can be agglomerated by a magnetic force produced therebetween, because the first magnetic nanoparticles 500 magnetize the adjacent second magnetic nanoparticles 600. This agglomeration of the magnetic nanoparticles enables a very small amount of target material to be detected. For example, the FeNi ferromagnetic nanoparticles bound to the surface of the silicon microcantilever are magnetized by a permanent magnet, and then the nanoparticles are reacted with the solution in which FeNi ferromagnetic nanoparticles having the same type as the FeNi ferromagnetic nanoparticles bound to the surface are dispersed, so that the FeNi ferromagnetic nanoparticles may be agglomerated together.

The reaction may be implemented once or more, two times or more, four times or more, six times or more, eight times or more, or ten times or more.

Next, the change caused by the agglomeration of the first magnetic nanoparticles and the second magnetic nanoparticles is detected. The change may include a change in physical properties such as a change in mass, a change in optical properties, a change in electrical properties, or a change in magnetic properties. For example, as the mass and magnitude of the FeNi ferromagnetic nanoparticles are increased by the agglomeration of the FeNi ferromagnetic nanoparticles, the deflection of the silicon microcantilever and the change in resonant frequency may be detected simultaneously. That is, the silicon microcantilever is deflected by the magnetic force between the magnetic nanoparticles and the permanent magnet, so that an increase in magnetic force can be detected. In addition, irrespective of the permanent magnet, the resonant frequency is decreased by the agglomeration of the magnetic nanoparticles, so that the change in mass can be detected.

When the target material is detected by using the agglomeration of the magnetic nanoparticles, the sensitivity of the biosensor can be improved as compared to a method by which the target material is detected prior to the agglomeration of the magnetic nanoparticles. For example, when the target material is detected using the agglomeration between the magnetic nanoparticles, the intensity of the magnetic force can be about 10 times or greater than the magnetic force before the agglomeration, so the sensitivity of the biosensor can be further improved.

Moreover, when the target material is detected by using the agglomeration between the magnetic nanoparticles, the target material can be detected more rapidly than when the target material is detected prior to the agglomeration of the magnetic nanoparticles. For example, when the target material is detected by using the agglomeration between the magnetic nanoparticles, the required time for the detection can be decreased to about ½ or less, about ⅕ or less, about 1/10 or less, about 1/20 or less, about 1/50 or less, or about 1/100 or less as compared to when the target material is detected without the agglomeration of the magnetic nanoparticles.

According to the above-described method, the biosensor capable of detecting the target material rapidly and with high sensitivity can be implemented. Therefore, the biosensor capable of efficient detection of the target material having low concentration can be developed.

Hereinafter, for a more complete understanding of this disclosure, various examples are presented below. The examples are merely for illustrative purposes, and the scope of the present invention should not be construed as being limited to examples described below.

### Example 1

The following example illustrates the preparation of a biosensor comprising a microcantilever sensor platform.

First, surfaces of FeNi ferromagnetic nanoparticles having a size of 100 nm were treated with an APTES, and a hydrophilic thin film having an amine group was formed. And then, unreacted silane molecules were removed by centrifugation. The surfaces of the FeNi ferromagnetic nanoparticles were reformed to have an aldehyde group by the reaction of the hydrophilic thin film with glutaraldehyde (“GA”). Then, a polyclonal AFP antibody was immobilized on the surfaces. A bovine serum albumin (“BSA”) was immobilized on the unreacted surfaces, and removed by centrifugation.

The surface of the silicon microcantilever was treated with the APTES and the GA using the same method as above mentioned, the polyclonal AFP was immobilized on the treated surface, and then the bovine serum albumin (“BSA”) was immobilized on an unreacted surface.

After reacting 100 ng/ml of the AFP antigen with the AFP antibody immobilized on the surface of the silicon microcantilever for one hour, the resulting reactant was bound to the FeNi ferromagnetic nanoparticles with the AFP antibody immobilized thereon using a sandwich method.

The ferromagnetic nanoparticles on the silicon microcantilever were magnetized by a permanent magnet, and the resulting nanoparticles were reacted with a solution having the same type of FeNi ferromagnetic nanoparticles dispersed therein for ten seconds. The magnetization and the reaction were repeatedly performed.

### Example 2

The following example illustrates the detection of a target material based on a change in microcantilever deflection due to magnetization using the microcantilever sensor platform prepared in Example 1.

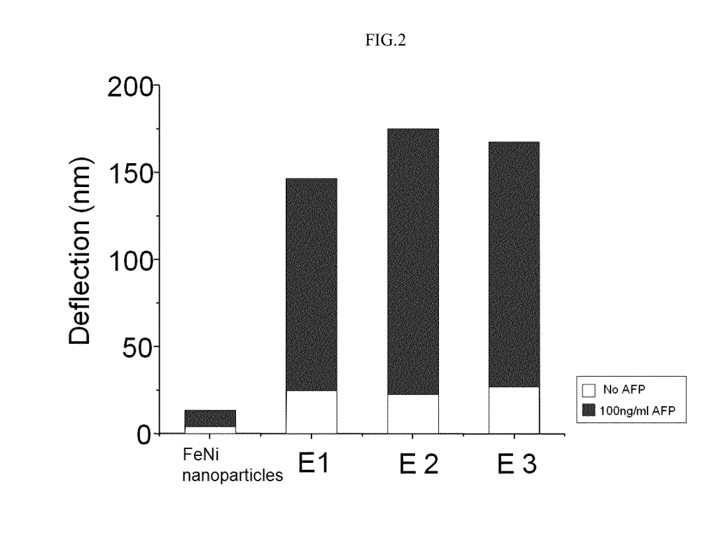

Referring to FIG. 2, when FeNi ferromagnetic nanoparticles having no AFP antigen were reacted with the surface of a microcantilever, the microcantilever was deflected by about 3 nm in the direction of a magnet by a non-specific reaction. When the FeNi ferromagnetic nanoparticles reacted with the AFP antigen were immobilized on the surface of the microcantilever, the microcantilever was deflected by about 13 nm in the direction of the magnet.

Meanwhile, after the FeNi ferromagnetic nanoparticles reacted with the AFP antigen were immobilized and magnetized on the surface of the microcantilever, when the microcantilever was agglomerated in the FeNi ferromagnetic solution for ten seconds, the cantilever was deflected by about 150 nm in the direction of the magnet. In addition, the more frequent the agglomeration reaction, the greater the cantilever deflection. As can be seen therein, as the intensity of the magnetic force by the agglomeration of the ferromagnetic nanoparticles was increased, its signal was increased about 13 times more than before the agglomeration.

### Example 3

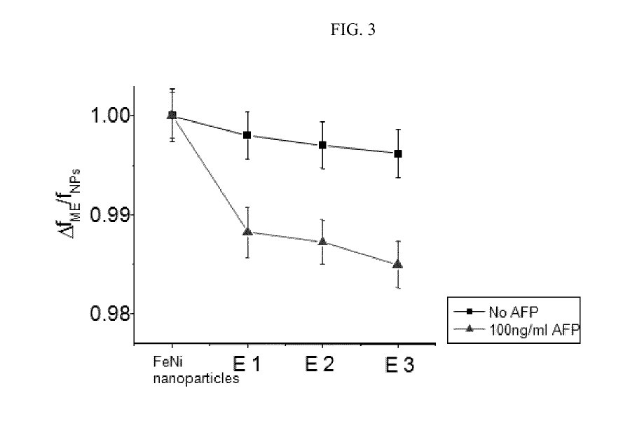

The following example illustrates detection of a target material based on a change in resonant frequency of the microcantilever due to magnetization using the microcantilever sensor platform prepared in Example 1. The result was shown in FIG. 3.

Referring to FIG. 3, the FeNi ferromagnetic nanoparticles reacted with the AFP antigen were immobilized and magnetized on the surface of the cantilever, and then the resulting cantilever was agglomerated in the FeNi ferromagnetic solution for 10 seconds, thereby further reducing the resonant frequency. Moreover, the more frequent the agglomeration reaction, the less the resonant frequency. As can be seen therein, as the resonant frequency was reduced by the agglomeration of the ferromagnetic nanoparticles, the mass was increased in comparison with that prior to the agglomeration.

According to the result of the examples above described, it could be seen that the sensitivity of the biosensor was improved using the agglomeration of the magnetic nanoparticles, and the target material could be detected more rapidly.

While exemplary embodiments have been disclosed herein, it should be understood that other variations may be possible. Such variations are not to be regarded as a departure from the spirit and scope of exemplary embodiments of the present application, and all such modifications as would be obvious to one skilled in the art are intended to be included within the scope of the following claims.

What is claimed is:

1. A biosensor comprising:
a substrate;
a first receptor immobilized on the substrate, the receptor capable of specifically reacting with a target material;
first magnetic nanoparticles, each comprising a second receptor immobilized thereon, wherein the first and second receptors are of the same type;
a magnetic field source positioned to apply a magnetic field to the first magnetic nanoparticles; and
second magnetic nanoparticles that agglomerate with the first magnetic nanoparticles in the presence of a magnetic field.

2. The biosensor according to claim 1, wherein the target material comprises an enzyme substrate, a ligand, an antigen, an antibody, a nucleotide, an amino acid, a peptide, a protein, a nucleic acid, a lipid, a carbohydrate, an organic compound, an inorganic compound, or combination thereof.

3. The biosensor according to claim 1, wherein the substrate comprises silicon, glass, quartz, metal, plastic, or combination thereof.

4. The biosensor according to claim 1, wherein the first magnetic nanoparticles and the second magnetic nanoparticles each independently comprise ferromagnetic nanoparticles or paramagnetic nanoparticles.

5. The biosensor according to claim 4, wherein the ferromagnetic nanoparticles comprise cobalt, iron, nickel, an alloy thereof, or combination thereof.

6. The biosensor according to claim 4, wherein the paramagnetic nanoparticles comprise aluminum, tin, platinum, or combination thereof.

7. The biosensor according to claim 1, wherein the substrate and the first magnetic nanoparticles are treated with at least one selected from aminopropyltriethoxysilane (“APTES”), glycidoxypropyltrimethoxysilane (“GPTS”), triethoxysilane undecanoic acid (“TETU”), polylysine, and 4-trimethoxysilylbenzaldehyde.

8. The biosensor according to claim 7, wherein the substrate and the first magnetic nanoparticles are further treated with glutaraldehyde or acetic acid.

9. The biosensor according to claim 1, wherein the magnetic field source is a permanent magnet.

10. The biosensor according to claim 1, wherein the biosensor comprises a mass-based sensor, an optical sensor, an electrical sensor, or a magnetic force-based sensor.

11. A method of detecting a target material, comprising:
immobilizing a first receptor on a substrate, the receptor capable of specifically reacting with a target material;
immobilizing a second receptor of the same type as the first receptor on each of a plurality of first magnetic nanoparticles;
reacting a target material with the first receptor immobilized on the substrate and the receptor immobilized on the first magnetic particles, thereby binding the first magnetic nanoparticles to the substrate;
magnetizing the first magnetic nanoparticles;
adhering second magnetic nanoparticles to the first magnetic nanoparticles; and
detecting agglomeration of the first magnetic nanoparticles and the second magnetic nanoparticles on the substrate,
wherein agglomeration of the first magnetic nanoparticles and the second magnetic nanoparticles on the substrate indicates the presence of the target material.

12. The method according to claim 11, wherein the magnetizing the first magnetic nanoparticles comprises applying a magnetic field to the first magnetic nanoparticles.

13. The method of claim 12 comprising applying a magnetic field to the first magnetic nanoparticles repeatedly at least two times.

14. The method according to claim 11, wherein the target material comprises an enzyme substrate, a ligand, an antigen, an antibody, a nucleotide, an amino acid, a peptide, a protein, a nucleic acid, a lipid, a carbohydrate, an organic compound, an inorganic compound, or combination thereof.

15. The method according to claim 11, wherein the substrate comprises silicon, glass, quartz, metal, plastic, or a combination thereof.

16. The method according to claim 11, wherein the first magnetic nanoparticles and the second magnetic nanoparticles independently comprise ferromagnetic nanoparticles or paramagnetic nanoparticles.

17. The method according to claim 16, wherein the ferromagnetic nanoparticles comprise cobalt, iron, nickel, an alloy thereof, or combination thereof.

18. The method according to claim 16, wherein the paramagnetic nanoparticles comprise aluminum, tin, or platinum, or combination thereof.

19. The method according to claim 11, wherein agglomeration of magnetic nanoparticles is detected by detecting a change in mass, a change in optical properties, a change in electrical properties, a change in magnetic properties, or a combination thereof.

20. The method according to claim 19, wherein agglomeration of magnetic nanoparticles is detected by simultaneously detecting a change in mass and a change in magnetic properties.

21. The biosensor of claim 1, wherein the second magnetic nanoparticles do not react with the target material.

22. The method of claim 11, wherein the second magnetic nanoparticles do not react with the target material.

23. A multi-component probe set for a target material comprising
at least one first magnetic nanoparticle comprising a receptor for a target material; and
a plurality of second magnetic nanoparticles that are different from the first magnetic nanoparticle, and which agglomerate with the first magnetic nanoparticle in the presence of a magnetic field.

24. A biosensor comprising
at least one first magnetic nanoparticle comprising a receptor for a target material;
a plurality of second magnetic nanoparticles that are different from the first magnetic nanoparticle, and which agglomerate with the first magnetic particle in the presence of a magnetic field;
a magnetic field source configured to apply a magnetic field to the magnetic nanoparticles; and
a sensor that detects agglomeration of the first magnetic particle with a plurality of second magnetic particles.
